(19) United States
(12) Patent Application Publication
(10) Pub. No.: US 2009/0063595 A1
(43) Pub. Date: Mar. 5, 2009

(54) METHOD AND APPARATUS FOR UPDATING REFERENCES TO OBJECTS IN A GARBAGE COLLECTION OPERATION

(76) Inventor: Mark Graham Stoodley, Markham (CA)

Correspondence Address: IBM CORP (YA);C/O YEE & ASSOCIATES PC, P.O. BOX 802333, DALLAS, TX, 75380, US

(21) Appl. No.: 11/850,174

(22) Filed: Sep. 5, 2007

(51) Int. Cl. G06F 17/30

(52) U.S. Cl. 707/206; 707/E17.005

(57) ABSTRACT

The illustrative embodiments described herein provide a computer-implemented method, apparatus, and computer program product for updating references to objects. The process identifies a set of references associated with a set of live objects at a garbage collection safe point in response to detecting the garbage collection safe point. The set of live objects are at a set of first locations in a storage device. The process updates the set of references such that the set of references refer to a set of second locations of the set of live object in response to detecting a garbage collection operation. The set of second locations is in the storage device.

### BACKGROUND OF THE INVENTION

1. Field of the Invention

The present invention relates generally to a data processing system and in particular to a method and system for updating references to objects. More particularly, the present invention is directed to a computer-implemented method, apparatus, and computer-usable program code for updating references to objects in a garbage collection operation.

2. Description of the Related Art

As storage space on a storage device is allocated to objects in a data processing system, a need often arises to manage the objects on the storage device. An object is any set of data that occupies memory, such as a bit, a byte, or a data structure. One reason why objects on the storage device may need to be managed is to increase the amount of available storage space on the storage device, thereby allowing additional objects to be allocated to the storage device.

Modern data processing systems often use “garbage collection” as a way to manage objects in a storage device. Execution environments, such as Java Virtual Machine, employ garbage collection to free programmers from the burden of managing dynamic memory allocation, which can be a laborious and time-consuming process. A garbage collection operation is an operation that manages the location of objects in a storage device. For example, a garbage collection operation may delete or move objects that are unreachable due to an absence of references or other objects that refer or point to the unreachable object.

In another example, a garbage collection operation may move live objects from one location on the storage device to another location on the storage device. A live object is an object whose location in a storage device is indicated by a reference. Non-limiting examples of a reference include a pointer in a program, a pointer in an object, a static or global variable, a local variable, an operand stack value, a machine stack, and a machine register. When moving live objects, the garbage collection operation can prevent problems such as heap defragmentation, in which the available storage space has become filled with live objects such that successful allocations for additional objects cannot be made. The inability to successfully allocate additional objects is caused by a lack of space in between currently stored live objects. By moving the location of the live objects on the storage device, contiguous space can be created to allow for the successful allocation of additional objects.

While garbage collection automates some aspects of memory management, garbage collection can also raise performance issues. For example, when a garbage collection operation moves live objects, all references that point to the old location of the live objects must be updated to point to the new location of the live objects. However, when updating machine stacks or machine registers to point to the new location, the garbage collector must discern which stack locations and machine registers refer to object pointers. Thus, for compiler-generated code, meta-data is generated to describe which stack locations and machine registers contain live pointers for every stack frame on every thread's stack. A stack frame is a portion of a call stack that corresponds to a function, such as a subroutine in a program. A thread refers to a thread of execution in a data processing system. However, in this example, because a large number of threads may be active, scanning and updating the stack locations can require excessive amounts of time.

Garbage collectors often require a pause in the execution of a program or threads of a program in which the garbage collection operation takes place. Hence, some garbage collectors provide a maximum pause time guarantee to minimize the amount of time a program or thread must be paused. In order to meet the time constraints imposed by a pause time guarantee, some garbage collectors add a new field to the header of all objects called a forwarding pointer. Before dereferencing any object pointer, the forwarding pointer must be followed if the object has been moved. Dereferencing means to access an object, value, or other pointer referred to by a reference. Also, because the forwarding pointer is typically initialized to point to the object in which the forwarding pointer is contained, any code that accesses an object may simply dereference the forwarding pointer before using the object reference. However, because of the additional processing time required to perform the extra dereferencing operation, this method has an adverse affect on processing speed. Because of the presence of the forwarding pointer, and because any code that accesses an object must dereference the forwarding pointer, a garbage collector may move an object without changing all the live references to that object. Thus, the garbage collection operation is able to complete without updating all references, thereby reducing the amount of time the program is paused.

Garbage collection may also be used during the execution of a program being compiled by a “just in time” compiler. A just in time compiler converts program code from one format to another at run time. Examples of modern run time environments that rely on just in time compilation for high-speed code execution include Microsoft®'s .NET framework and many implementations of Java®. Microsoft and .NET are trademarks of Microsoft Corporation in the United States, other countries, or both. Java™ and all Java™-based trademarks are trademarks of Sun Microsystems, Inc. in the United States, other countries, or both. However, because a garbage collection operation can occur at many different points in a program, and because of uncertainty as to whether underlying objects on which a program is operating requires forwarding, the just in time compiler is handicapped as to how the just in time compiler can optimize code.

### SUMMARY OF THE INVENTION

The illustrative embodiments described herein provide a computer-implemented method, apparatus, and computer program product for updating references to objects. The process identifies a set of references associated with a set of live objects at a garbage collection safe point in response to detecting the garbage collection safe point. The set of live objects are at a set of first locations in a storage device. The process updates the set of references such that the set of references refer to a set of second locations of the set of live objects in response to detecting a garbage collection operation. The set of second locations is in the storage device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which the illustrative embodiments may be implemented;

FIG. 2 is a block diagram of a data processing system in which the illustrative embodiments may be implemented;

FIG. 3 is a block diagram of a system for updating references to objects in accordance with an illustrative embodiment;

FIG. 4 is a function in a system for updating references to objects in accordance with an illustrative embodiment;

FIG. 5 is code in a system for updating references to objects in accordance with an illustrative embodiment;

FIG. 6 is a graphical representation of a system for updating references to objects in accordance with an illustrative embodiment;

FIG. 7 is a block diagram of a call stack in a system for updating references to objects in accordance with an illustrative embodiment;

FIG. 8 is a flowchart illustrating a process for updating references to objects in accordance with an illustrative embodiment;

FIG. 9 is a flowchart illustrating a process for updating references to objects in accordance with an illustrative embodiment; and

FIG. 10 is a flowchart illustrating a process for updating references to objects in accordance with an illustrative embodiment.

### DETAILED DESCRIPTION OF THE PREFERRED EMBODIMENT

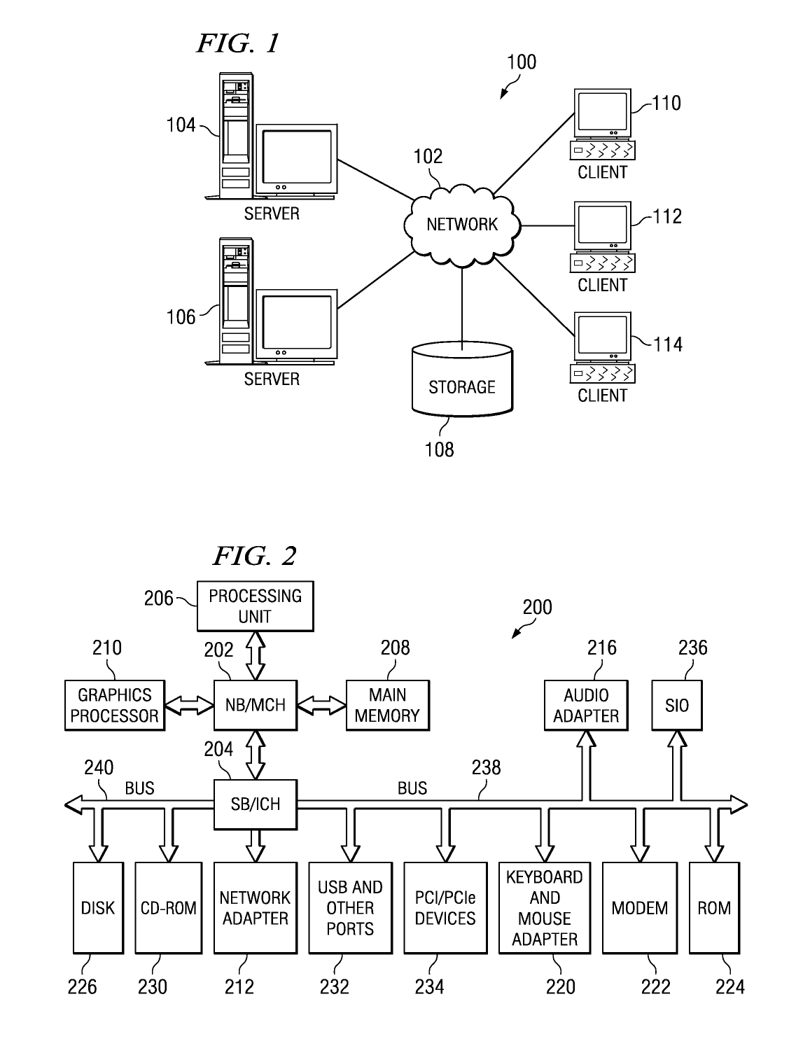

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. Storage unit 108 contains objects that may be managed by a garbage collection operation. Objects on storage unit 108 may be referenced by any one of servers 104 and 106 and clients 110, 112, and 114. In addition, any of servers 104 and 106 and clients 110, 112, and 114 may contain objects that are referenced or managed in a garbage collection operation by any of servers 104 and 106 and clients 110, 112, and 114.

In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Main memory may contain objects that are managed by a garbage collection system. In one example, the objects are referenced by a program that is executing on data processing system 200.

Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer-implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer-implemented method, apparatus, and computer program product for updating references to objects. The process identifies a set of references associated with a set of live objects at the garbage collection safe point in response to detecting the garbage collection safe point. The set of live objects are at a set of first locations in a storage device. A storage device is any device capable of storing data. The set of references include one or more references. A reference is any data that indicates a location in a storage device. The set of references may be a set of pointers. The set of pointers include one or more pointers. A pointer is a data type whose value refers to an object in a storage device using the object's address. An address is a particular location in a storage device. The set of live objects include one or more live objects. A garbage collection safe point is any point in a program at which a garbage collection operation can occur.

In one embodiment, each of the set of references is associated with a stack frame for a function. A stack frame is a portion of a call stack that corresponds to a function. Non-limiting examples of a function include a subroutine, method, procedure, or subprogram in a program. In this embodiment, the function may be called by a calling function associated with a second stack frame. The second stack frame is associated with a second set of references. Also, in this embodiment, the process may also set a variable to a first value in response to a determination that the set of live objects in the set of first locations have been moved to the set of second locations in the garbage collection operation. The process, in this embodiment, updates the second set of references in response to the variable having the first value.

The process updates the set of references such that the set of references refer to a set of second locations in response to detecting a garbage collection operation. In another embodiment, the process updates the set of references such that the set of references refer to a set of second locations in response to detecting that the set of live objects in a set of first locations have been moved to the set of second locations in a garbage collection operation. A garbage collection operation is an operation that manages the location of objects in a storage device. In one embodiment, the garbage collection operation occurs at the garbage collection safe point. A garbage collection operation may delete or move objects in a storage device. In this example, the deletion or movement of objects may facilitate increasing the amount of available space on a storage device to allow additional objects to be allocated to the storage device.

The set of first locations include one or more first locations. The set of second locations include one or more second locations. Also, the set of second locations are in a storage device. In one embodiment, the set of first locations and the set of second locations are addresses of the storage device.

In another embodiment, the process of updating the set of references such that the set of references refer to a set of second locations is implemented by a portion of code in a program that is separate from another portion of code in the program in which the garbage collection operation occurs. In another embodiment, the process of updating the set of references such that the set of references refer to a set of second locations is performed by a thread. In this embodiment, the thread is executing at the garbage collection safe point.

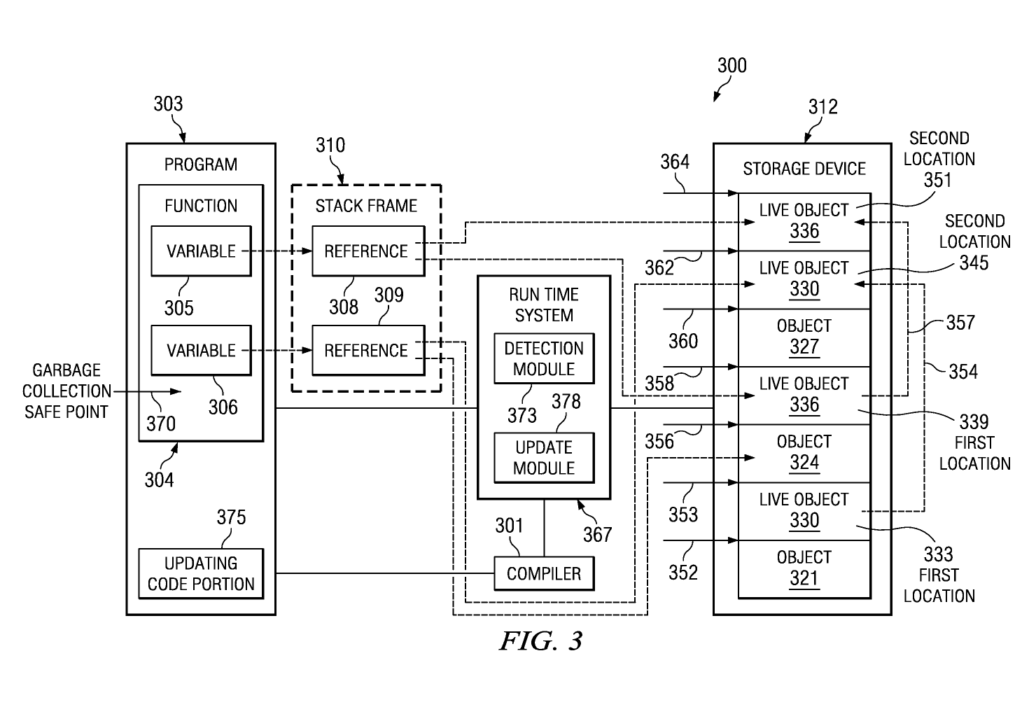

Turning now to FIG. 3, a block diagram of a system for updating references to objects is depicted in accordance with an illustrative embodiment. Specifically, FIG. 3 shows data processing system 300, which contains components to update references to objects in a garbage collection operation. Examples of data processing system 300 include data process system 100 in FIG. 1, data processing system 200 in FIG. 2, or any one of servers 104 and 106 and clients 110, 112, and 114 in FIG. 1.

Data processing system 300 includes program 303. Program 303 is a set of instructions that is executed on data processing system 300. Program 303 may be included in software, middleware, firmware, hardware, or any other media compatible with data processing system 300. Also, the instructions contained in program 303 may be expressed in any computer language. For example, program 303 may be expressed in Java, C#, C++, or Visual Basic. In one embodiment, program 303 is written using a programming language that is capable of being compiled using a just in time compiler.

Program 303 is compiled by compiler 301. In one embodiment, compiler 301 is a just in time compiler. Non-limiting examples of compiler 301 include Sun Studio, available from Sun Microsystems, and Visual Studio, available from Microsoft. In another embodiment, compiler 301 is an interpreter that interprets program 303. In another embodiment, compiler 301 is an “ahead-of-time” compiler. An “ahead-of-time” compiler generates program 303 before program 303 is executed.

Program 303 contains function 304. Function 304 is a portion of code within program 303 that performs a specific task. Non-limiting examples of function 304 include a method, subroutine, procedure, or subprogram in a program. Although program 303 is shown as having a single function 304, program 303 may have any number of functions.

Function 304 contains variables 305 and 306. In one example, variables 305 and 306 are local variables. Variables 305 and 306 use references 308 and 309 to indicate a location in storage device 312, respectively. References 308 and 309 may be pointers. References 308 and 309 refer to one or more objects in storage device 312 using the addresses of the one or more objects. References 308 and 309 are contained in stack frame 310. Stack frame 310 includes data for function 304, and may be included in a call stack containing data for multiple functions. Although references 308 and 309 are shown to be included in stack frame 310, references 308 and 309 may be included in any component of data processing system 300. For example, references 308 and 309 may be included in one or more objects or live objects in storage device 312, a static or global variable, an operand stack value, a machine stack, a machine register, or any combination thereof. Also, data processing system 300 may include any number of references at any these locations.

References 308 and 309 point to live object 336 and 330, respectively, in storage device 312. Storage device 312 is any device capable of storing data. In one embodiment, storage device 312 is random access memory, such as main memory 208 in FIG. 2. Storage device 312 may also be memory that is detachable from data processing system 300, such as a removable flash memory, a USB flash drive, an external hard drive, and a pocket hard drive. Such storage devices may be connectable to data processing system 300 via one or more ports, such USB and other ports 232 in FIG. 2. Other non-limiting examples of storage device 312 include a hard drive, such as hard disk drive 226 in FIG. 2, and an optical drive. Also, although storage device 312 is shown as having a direct connection to data processing system 300, storage device 312 may be connected to data processing system over a network, such as network 102 in FIG. 1.

Storage device 312 contains multiple objects and live objects. Specifically, storage device 312 contains objects 321, 324, and 327. Storage device 312 includes live objects 330 and 336, which are located at first locations 333 and 339 on storage device 312, respectively. Live objects 330 and 336 are also shown at second locations 345 and 351, respectively, where they reside after being moved in storage device 312. Live objects 330 and 336 are moved from first locations 333 and 339 to second locations 345 and 351 in move operations 354 and 357, respectively.

Also, each of the objects and live objects on storage device 312 are located at an address on storage device 312. Specifically, objects 321, 324, and 327 are located at addresses 352, 356, and 360 on storage device 312, respectively. Live objects 330 and 336 at first locations 333 and 339 are located at addresses 353 and 358 on storage device 312, respectively. Live objects 330 and 336 at second locations 345 and 351 are located at addresses 362 and 364 on storage device 312, respectively.

Data processing system 300 also includes run time system 367. Run time system 367 provides services for program 303 while program 303 is executing. In one embodiment, run time system 367 is separate from the operating system of data processing system 300. Among the services that run time system 367 may provide include code that is generated by compiler 301 to manage a run time stack, library code for handling memory management, code that handles dynamic loading and linking, debugger code that is generated at compile time or run time, and application-level thread management code. Byte-code interpreters and virtual machines, such as Java™ Virtual Machine, are also examples of run time system 367.

In one embodiment, run time system 367 identifies references 308 and 309 associated with live objects 330 and 336 at a garbage collection safe point. In one embodiment, references 308 and 309 are associated with a single stack frame for a function. In this embodiment, references 308 and 309 may comprise a register or a local variable for the function.

A garbage collection safe point is any point in a program at which a garbage collection operation can occur. Garbage collection safe point 370 is an example of a garbage collection safe point. References 308 and 309 occur at garbage collection safe point 370.

Additional examples of garbage collection safe points include program instructions, such as instruction in program 303, and call instructions that might cause an exception. Garbage collection safe points may also be caused by instruction sequences called async checks. Async checks, which determine whether the current thread should yield for a garbage collection operation, are often included in a function's code. Async checks may also be inserted into loops in program 303 such that the program code can quickly respond to a garbage collection operation that requires application threads to sleep.

In one embodiment, run time system 367 identifies references 308 and 309 associated with live objects 330 and 336 at a garbage collection safe point in response to detecting garbage collection safe point 370. Garbage collection safe point 370 may be detected by run time system 367, detection module 373, compiler 301, program 303, an operating system of data processing system 300, or any combination thereof.

Data processing system 300 includes detection module 373. Detection module 373 detects whether live objects, such as live objects 330 and 336, have been moved in storage device 312 during a garbage collection operation. In one embodiment, detection module 373 detects that live objects 330 and 336 in first locations 333 and 339 have been moved to second locations 345 and 351 in a garbage collection operation. In another embodiment, detection module 373 also detects that one of references 308 and 309 refers to one of first locations 333 and 339 after live objects 330 and 336 have been moved to second locations 345 and 351. In another embodiment, run time system 367 does not contain detection module 373 at all. In another embodiment, detection module 373 detects the occurrence of a garbage collection operation.

A garbage collection operation is an operation that manages the location of objects in a storage device. In FIG. 3, a garbage collection operation has occurred in which live objects 330 and 336 have been moved from first locations 333 and 339 to second locations 345 and 351, respectively. In one embodiment, first locations 333 and 339 and second locations 345 and 351 are indicated by addresses of storage device 312. In this embodiment, live object 330 is moved from address 353 to address 362 in a garbage collection operation, as indicated by move operation 354. Likewise, live object 336 is moved from address 358 to address 364 in a garbage collection operation, as indicated by move operation 357.

The garbage collection operation may occur at a garbage collection safe point. In one embodiment, detection module 373 detects whether a garbage collection operation has occurred at all during a garbage collection safe point.

Several ways exist for detection module 373 to detect whether live objects, such as live objects 330 and 336, have been moved in storage device 312 during a garbage collection operation. In one embodiment, detection module 373 sets a variable, such as a local variable, to the value of a counter. The value of the counter is determined prior to garbage collection safe point 370. Detection module 373 changes the value of the counter in response to detecting that live objects 330 and 336 in first locations 333 and 339 have been moved to second locations 345 and 351 in a garbage collection operation. In one example, detection module 373 changes the value of the counter by incrementing or decrementing the value of the counter. In response to detection module 373 comparing the variable to the counter, references 308 and 309 may then be updated such that references 308 and 309 refer to second locations 345 and 351. Detection module 373 may compare the variable to the counter after garbage collection safe point 370. In one embodiment, references 308 and 309 are updated such that references 308 and 309 refer to second locations 345 and 351 in response to the variable and the counter having a different value.

In another embodiment, detection module 373 sets a flag to a predetermined value in response to detecting that live objects 330 and 336 in first locations 333 and 339 have been moved to second locations 345 and 351 in a garbage collection operation. The flag may be a boolean flag, and the flag may be included in one or more threads of execution in data processing system 300. In response to the flag having the predetermined value, references 308 and 309 may then be updated such that references 308 and 309 refer to second locations 345 and 351. In one embodiment, code in program 303, after garbage collection safe point 370, determines whether the flag has the predetermined value. The determination as to whether the flag has the predetermined value may also be made by run time system 367 or compiler 301. After references 308 and 309 may then be updated such that references 308 and 309 refer to second locations 345 and 351, the flag may be cleared.

In another embodiment, an async check operation detects that live objects 330 and 336 in first locations 333 and 339 have been moved to second locations 345 and 351 in a garbage collection operation. In this embodiment, the asynchronous check operation determines whether a garbage collection operations needs to execute. If a garbage collection operation needs to execute, then the async operation will yield the processor in data processing system 300 and wait for the garbage collection operation to finish executing. After the garbage collection operation finishes executing and before control is transferred back to program 303 to continue executing, the async operation may detect that live objects 330 and 336 in first locations 333 and 339 have been moved to second locations 345 and 351 in a garbage collection operation.

In response to a garbage collection operation, updating code portion 375 updates references 308 and 309 such that references 308 and 309 refer to second locations 345 and 351. In another embodiment, updating code portion 375 updates references 308 and 309 in response to detecting that live objects 330 and 336 in first locations 333 and 339 have been moved to second locations 345 and 351 in a garbage collection operation. In one embodiment, updating code portion 375 is separate from another portion of code in program 303 at which the garbage collection operation occurs. In one example, updating code portion 375 is located near the end of a function or method's code.

Furthermore, the instruction contained in updating code portion 375 may be performed by a thread of execution that is executing at garbage collection safe point 370. Although updating code portion 375 is shown to be included in program 303, updating code portion 375 may be located in any components of data processing system 300, such as run time system 367.

Updating code portion 375 may update references 308 and 309 such that references 308 and 309 refer to second locations 345 and 351 in a variety of ways. In one embodiment, updating code portion 375 calls a run time function that takes, as an argument, a pointer to the stack map generated by compiler 301 for garbage collection safe point 370. In this embodiment, the stack map may already be generated by compiler 301 so that all live object references at garbage collection safe point 370 may be found. The run time function may also examine the stack map to find the live object references, such as references 308 and 309, and update them explicitly. The stack map includes both live local variables and live registers. The presence of the run time function in updating code portion 375 will impact how registers are allocated across garbage collection safe point 370 because the registers needed to perform the call will be taken into account. After the run time function returns, control is directed back to the instructions in program 303 following garbage collection safe point 370.

In another non-limiting embodiment in which updating code portion 375 updates references 308 and 309 such that references 308 and 309 refer to second locations 345 and 351, updating code portion 375 contains explicit instructions to update the live references, such as references 308 and 309, based on the location at which compiler 301 knows those live references to reside. For example, if only three registers contain references, then the instructions to update those precise registers may be generated inside updating code portion 375. Local variables that hold references to objects can be similarly updated. After the references have been updated, control is directed back to the instruction of program 303 following garbage collection safe point 370.

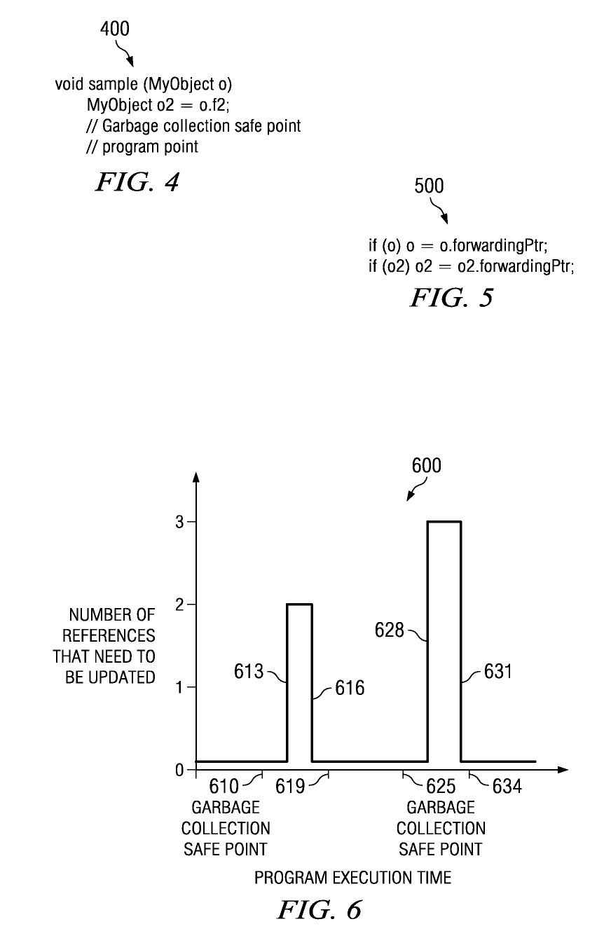

In one example of the operation of data processing system 300, program 303 contains function 400 in FIG. 4. Function 400 is a non-limiting example of function 304 in FIG. 3.

In function 400, “o” and “o2” are local variables, such as local variables 305 and 306. Local variables o and o2 each hold a reference, such as references 308 and 309, to an object, such as live objects 330 and 336. In one example, the object that is referenced by local variable o2 is located at address 353, which is the location of the object o.f2 on storage device 312. In the example, a garbage collection safe point, such as garbage collection safe point 370, occurs after object o.f2 is stored into local variable o2. A garbage collection operation that occurs at the garbage collection safe point may move object o.f2 to address 362 in storage device 312. In response to the occurrence of either the garbage collection safe point or the garbage collection operation, updating code portion 375 may be executed such that the references associated with local variable o2 references address 362, which is the new location object o.f2. In one example, updating code portion 375 contains code 500 in FIG. 5.

Code 500 may be used to update the references associated with local variables o and o2. However, in one embodiment, if compiler 301 detects that local variable o will not be used later in the function, then the exemplary updating code portion does not need to include the statement “if (o) o=o.forwardingPtr.” In another embodiment, if compiler 301 can prove that o cannot be a null pointer, then the exemplary updating code portion does not need to include the “if (o)” guard. In another embodiment, if compiler 301 can prove that the local variable o must be a null pointer, than the exemplary updating code portion does not need to include the statement “if (o) o=o.forwardingPtr.” After executing the updating code portion, execution is transferred back to the program point following the garbage collection safe point.

Turning back to FIG. 3, a combination of the aforementioned embodiments of updating code portion 375 may be used in a single implementation. For example, the second illustrative embodiment, in which updating code portion 375 contains explicit instructions to update the live references based on the location at which compiler 301 knows those live references to reside, may be used for garbage collection safe points in the innermost loops of a method or function because of the lack of register used constraints imposed by this embodiment of updating code portion 375. In another example, the first illustrative embodiment, in which updating code portion 375 calls a run time function that takes, as an argument, a pointer to the stack map, may be used in garbage collection safe points in less frequently executed parts of program 303 because the additional register constraints will not impact program performance as much and updating code portion 375 will be smaller.

Another way to decide which illustrative embodiment of updating code portion 375 to use is based on the number of available registers at garbage collection safe point 370. For example, if enough registers are present such that the run time function will not cause any additional register spills, then the first illustrative embodiment for updating code portion 375 may be used. In another example, when free registers are not plentiful enough, the second illustrative embodiment for updating code portion 375 may be used.

Alternatively, updating code portion 375 may be inserted directly into a function or method's code. However, because garbage collection operations and cycles rarely occur, updating code portion 375 may also be located at the end of a function or method where the updating code portion 375 will have a lower expected impact on the performance of the more frequently executed code.

Also, updating code portion 375 is not limited only to updating references. Other forms of program instrumentation, such as tracking how many live object references are contained at a garbage collection safe point, may be inserted into updating code portion 375. These other forms of program instrumentation may be performed in addition to or in lieu of updating references.

In this manner, the illustrative embodiments describe a mechanism whereby references that point to moved objects are lazily updated by generated code with the code itself performing updating or forwarding operations. The first time an object reference is loaded from memory, the object reference must be updated. From that point forward, the compiler may assume that the reference does not change. If a garbage collection operation moves objects, then the generated code will explicitly update any object references in, for example, registers or local variables that are live when garbage collection occurs on a frame-by-frame basis. The compiler may then apply the optimizations that the compiler would normally apply.

Turning now to FIG. 6, a graphical representation of a system for updating references to objects is depicted in accordance with an illustrative embodiment. Specifically, graphical representation 600 is a graph of the number of references that need to be updated as a function of program execution time. Graphical representation 600 is an example of the operation of data processing system 300 in FIG. 3 over time.

Program execution time, which corresponds to the x-axis of graphical representation 600, is an example of the execution of program 303 in FIG. 3 over time. As the program executing, garbage collection safe point 610 is reached. At garbage collection safe point 610, a garbage collection operation moves two live objects pointed to by references at garbage collection safe point 610. The movement of the two live objects occurs in a storage device, such as storage device 312 in FIG. 3. The movement of the two live objects is represented by graph line portion 613.

As shown in graphical representation 600, two references need to be updated due to the movement of the two live objects in the storage device. Upon detecting that two live objects in the storage device have been moved in the garbage collection operation, the two references are updated to point to the new locations of the live objects, as represented by graph line portion 616. At point 619, control returns to the instructions in the program following garbage collection safe point 610.

As the program continues to execute, garbage collection safe point 625 is reached. At garbage collection safe point 625, a garbage collection operation moves three live objects pointed to by references at garbage collection safe point 625. The movement of the three live objects occurs in the storage device. The movement of the three live objects is represented by graph line portion 628.

As shown in graphical representation 600, three references need to be updated due to the movement of the three live objects in the storage device. Upon detecting that three live objects in the storage device have been moved in the garbage collection operation, the three references are updated to point to the new locations of the live objects, as represented by graph line portion 631. At point 634, control returns to the instructions in the program following garbage collection safe point 625.

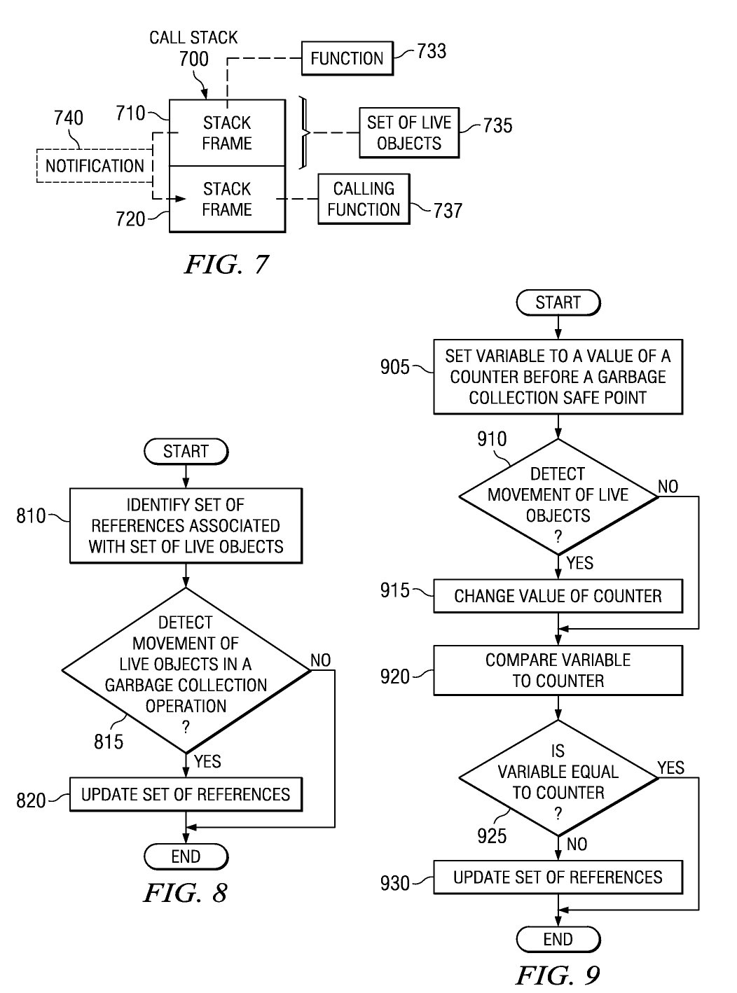

Turning now to FIG. 7, a block diagram of a call stack in a system for updating references to objects is depicted in accordance with an illustrative embodiment. Specifically, FIG. 7 shows call stack 700, which includes stack frames 710 and 720. Stack frames 710 and 720 are each associated with a function, such as functions that occur in program 303 in FIG. 3. Call stack 700 illustrates a non-limiting embodiment in which a higher stack frame has an associated function that calls another function associated with a lower stack frame. The higher stack frame is notified when live objects associated with the lower stack frame are moved in a storage device during a garbage collection operation. Alternatively, the higher stack frame is notified when a garbage collection operation occurs in the function associated with the lower stack frame.

Stack frame 710 stores data for function 733. Function 733 includes a first set of references. Non-limiting examples of a reference in the first set of references include a register and a local variable.

Function 733 is called by calling function 737. Stack frame 720 stores data for calling function 737. Calling function 737 includes a second set of references.

In one embodiment, a garbage collection operation moves set of live objects 735, which are referenced by the first set of references. Set of live objects 735 are moved within a storage device, such as storage device 312 in FIG. 3. In response to detecting that set of live objects 735 have been moved during the garbage collection operation, a variable is set to a first value. The variable may be a local boolean variable that is allocated in every stack frame to capture whether a garbage collection operation that moved objects occurred while executing the function.

In response to the variable having the first value, the second set of references, which are associated with stack frame 720, are updated. In another embodiment, the set second of references may be updated in response to the occurrence of a garbage collection operation during the execution of function 733. In one example, upon returning from function 733, if the local boolean variable that is allocated to stack frame 710 is set, then a per-thread boolean flag for stack frame 720 is also set such that calling function 737 will detect that the second set of references, which references live objects, must be updated. The same process must be followed by a run time system that handles exception propagation from one frame to another. The per-thread boolean flag must be set in the frame where the exception will ultimately be handled.

If, for example, an exception is thrown in function 733 after the garbage collection operation that moved set of live objects 735, then the run time system, such as run time system 367 in FIG. 3, may be invoked to handle the throwing of the exception. If the correct handler for the exception resides in calling function 737, then the run time system will direct execution to the handler entry point in calling function 737. Prior to directing execution to the handler, however, the per-thread boolean value must be set so that the handler entry point in calling function 737 can detect that a third set of references, which references objects that are live at the exception handler entry point in calling function 737, must be updated. Because the program point in calling function 737 from which function 733 was called is not the same program point as the exception handler entry point, the third set of references may be different than the second set of references.

Thus, stack frame 720 is notified that the second set of references with which stack frame 720 is associated needs to be updated. This notification is represented by notification 740.

Turning now to FIG. 8, a flowchart illustrating a process for updating references to objects is depicted in accordance with an illustrative embodiment. The process illustrated in FIG. 8 may be implemented by a run time system, such as run time system 367 in FIG. 3, a code portion, such as updating code portion 375 in FIG. 3, or any combination thereof.

The process begins by identifying a set of references associated with a set of live objects at the garbage collection safe point (step 810). The process determines whether the movement of the set of live objects in a garbage collection operation is detected (step 815).

If the process determines that the movement of the set of live objects in a garbage collection operation is detected, the process updates the set of references (step 820). In another embodiment, the process updates the set of references in response to detecting a garbage collection operation, regardless of whether live objects were moved during the garbage collection operation. The process then terminates. Returning to step 815, if the process determines that the movement of the set of live objects in a garbage collection operation is not detected, then the process terminates.

Turning now to FIG. 9, a flowchart illustrating a process for updating references to objects is depicted in accordance with an illustrative embodiment. The process illustrated in FIG. 9 may be implemented by a run time system, such as run time system 367 in FIG. 3, a code portion, such as updating code portion 375 in FIG. 3, a garbage collector, or any combination thereof. Also, the process illustrated in FIG. 9 is an illustrative embodiment of the process implemented for steps 815 and 820 in FIG. 8.

The process begins by setting a variable to a value of a counter before a garbage collection safe point (step 905). The process determines whether a movement of live objects in a storage device is detected (step 910). If the process determines that a movement of live objects in a storage device is detected, then the process changes the value of the counter (step 915). For example, the counter may be incremented.

Returning to step 910, if the process determines that a movement of live objects in a storage device is not detected, then the process proceeds to step 920. The process also compares the variable to the counter (step 720). The process determines whether the variable is equal to the counter (step 925).

If the process determines that the variable is not equal to the counter, the process updates a set of references associated with a set of live objects at a garbage collection safe point (step 930). The process then terminates. Returning to step 925, if the process determines that the variable is equal to the counter, then the process terminates.

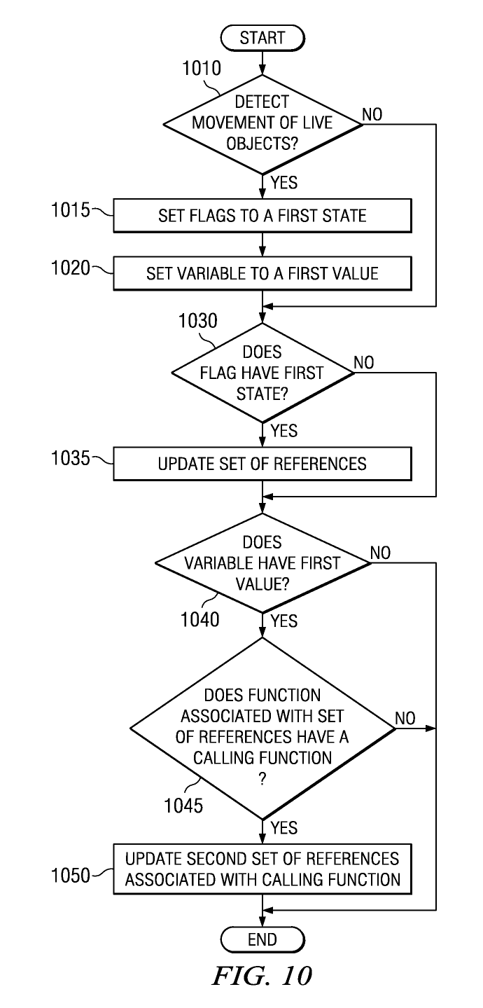

Turning now to FIG. 10, a flowchart illustrating a process for updating references to objects is depicted in accordance with an illustrative embodiment. The process illustrated in FIG. 10 may be implemented by a run time system, such as run time system 367 in FIG. 3, a code portion, such as updating code portion 375 in FIG. 3, or any combination thereof. Also, the process illustrated in FIG. 10 is an illustrative embodiment of the process implemented for steps 815 and 820 in FIG. 8.

The process begins by determining whether the movement of live objects is detected (step 1010). If the movement of live objects is detected, the process sets a flag to a first state (step 1015). The process also sets a variable to a first value (step 1020). Returning to step 1010, if the process determines that the movement of live objects is not detected, then the process proceeds to step 1030.

The process determines whether the flag has the first state (step 1030). If the process determines that the flag has the first state, then the process updates the set of references (step 1035). Returning to step 1030, if the process determines that the flag does not have the first state, then the process proceeds to step 1040.

The process determines whether the variable has the first value (step 1040). If the process determines that the variable does not have the first value, then the process terminates. If the process determines that the variable has the first value, then the process determines whether the function associated with the set of references has a calling function (step 1045).

If the process determines that the function associated with the set of references does not have a calling function, then the process terminates. If the process determines that the function associated with the set of references has a calling function, then the process updates a second set of references associated with the calling function (step 1050). The process then terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide a computer-implemented method, apparatus, and computer program product for updating references to objects. The process identifies a set of references associated with a set of live objects at the garbage collection safe point in response to detecting the garbage collection safe point. The set of live objects are at a set of first locations in a storage device.

In one embodiment, each of the set of references is associated with a stack frame for a function. A stack frame is a portion of a call stack that corresponds to a function. Non-limiting examples of a function include a subroutine, method, procedure, or subprogram in a program. In this embodiment, the function may be called by a calling function associated with a second stack frame. The second stack frame is associated with a second set of references. Also, in this embodiment, the process may also set a variable to a first value in response to a determination that the set of live objects in the set of first locations have been moved to the set of second locations in the garbage collection operation. The process, in this embodiment, updates the second set of references in response to the variable having the first value.

The process updates the set of references such that the set of references refer to a set of second locations in response to detecting a garbage collection operation. In another embodiment, the process updates the set of references such that the set of references refer to a set of second locations in response to detecting that the set of live objects in a set of first locations have been moved to the of second locations in a garbage collection operation. In one embodiment, the set of first locations and the set of second locations are addresses of the storage device.

In another embodiment, the process of updating the set of references such that the set of references refer to a set of second locations is implemented by a portion of code in a program that is separate from another portion of code in the program in which the garbage collection operation occurs. In another embodiment, the process of updating the set of references such that the set of references refer to a set of second locations is performed by a thread. In this embodiment, the thread is executing at the garbage collection safe point.

In traditional garbage collection operations, updating live object references is performed en masse during the garbage collection cycle. Some garage collectors, especially those with maximum pause time guarantees, force the program to always forward object pointers before dereferencing them. The illustrative embodiments describe a lazy form of updating live object references that is performed by the program itself on a stack frame-by-stack frame based via modifications to the compiler-generated code. Updating is applied when the garbage collection operation may not have updated all pointers to a moved object, and live pointers to objects will be updated as each frame is processed.

Object pointers loaded from memory are still updated. Once loaded, the compiler is free to optimize such pointers because an updating code portion can guarantee that the most recent address of the referenced object will be used during program execution.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for updating references to objects, the computer-implemented method comprising:
responsive to detecting a garbage collection safe point, identifying a set of references associated with a set of live objects at the garbage collection safe point, wherein the set of live objects are located in a set of first locations in a storage device; and
responsive to detecting a garbage collection operation, updating the set of references to refer to a set of second locations for the set of live objects, wherein the set of second locations is in the storage device.

2. The computer-implemented method of claim 1, wherein detecting the garbage collection operation further comprises:
detecting that the set of live objects in the set of first locations have been moved to the set of second locations in the garbage collection operation.

3. The computer-implemented method of claim 2, wherein detecting that the set of live objects in the set of first locations have been moved to the set of second locations in the garbage collection operation further comprises:
detecting that a reference in the set of references refers to a first location in the set of first locations for a live object in the set of live objects.

4. The computer-implemented method of claim 2, wherein detecting that the set of live objects in the set of first locations have been moved to the set of second locations in the garbage collection operation further comprises:
setting a variable to a first value, wherein the first value is equal to a value for a counter prior the garbage collection safe point;
responsive to detecting that the set of live objects in the set of first locations have been moved to the set of second locations in the garbage collection operation, changing the counter to a second value;
responsive to comparing the variable to the counter, performing the updating.

5. The computer-implemented method of claim 1, wherein the garbage collection operation occurs at the garbage collection safe point.

6. The computer-implemented method of claim 1, wherein each of the set of references is associated with a first stack frame for a function.

7. The computer-implemented method of claim 6, wherein the function is called by a calling function associated with a second stack frame, wherein the second stack frame is associated with a second set of references, further comprising:
responsive to detecting that the set of live objects in the set of first locations have been moved to the set of second locations in the garbage collection operation, setting a variable to a first value; and
responsive to the variable having the first value, updating the second set of references.

8. The computer-implemented method of claim 1, wherein the set of references are used by a set of local variables.

9. The computer-implemented method of claim 1, wherein detecting that the set of live objects in the set of first locations have been moved to the set of second locations in the garbage collection operation further comprises:
responsive to detecting that the set of live objects in the set of first locations have been moved to the set of second locations in the garbage collection operation, setting a flag to a first value;
responsive to the flag having the first value, performing the updating;
responsive to the updating, clearing the flag.

10. The computer-implemented method of claim 1, wherein the set of first locations and the set of second locations are addresses of the storage device.

11. The computer-implemented method of claim 1, wherein the set of references comprise a set of pointers.

12. The computer-implemented method of claim 1, wherein the updating is implemented by a portion of code that is separate from another portion of code at which the garbage collection operation occurs.

13. The computer-implemented method of claim 1, wherein the updating is performed by a thread, wherein the thread is executing at the garbage collection safe point.

14. A computer program product comprising:
a computer-usable medium having computer-usable program code for updating references to objects, the computer program product comprising:
computer-usable program code, responsive to detecting a garbage collection safe point, for identifying a set of references associated with a set of live objects at the garbage collection safe point, wherein the set of live objects are located in a set of first locations in a storage device; and
computer-usable program code, responsive to detecting a garbage collection operation, for updating the set of references to refer to a set of second locations for the set of live objects, wherein the set of second locations is in the storage device.

15. The computer program product of claim 14, wherein detecting the garbage collection operation further comprises:
computer-usable program code for detecting that the set of live objects in the set of first locations have been moved to the set of second locations in the garbage collection operation.

16. The computer program product of claim 15, wherein the computer-usable program code for detecting that the set of live objects in the set of first locations have been moved to the set of second locations in the garbage collection operation further comprises:
computer-usable program code for detecting that a reference in the set of references refers to a first location in the set of first locations for a live object in the set of live objects.

17. The computer program product of claim 14, wherein the updating is implemented by a portion of code that is separate from another portion of code at which the garbage collection operation occurs.

18. A data processing system comprising:
a bus system;
a memory connected to the bus system, wherein the memory includes a set of instructions; and
a processing unit connected to the bus system, wherein the processing unit executes the set of instructions to identify a set of references associated with a set of live objects at a garbage collection safe point in response to detecting the garbage collection safe point, wherein the set of live objects are located in a set of first locations in a storage device; and updating the set of references to refer to a set of second locations for the set of live objects in response to detecting a garbage collection operation, wherein the set of second locations is in the storage device.

19. The data processing system of claim 18, wherein in executing the set of instructions to detect the garbage collection operation, the processing unit further executes the set of instructions to detect that the set of live objects in the set of first locations have been moved to the set of second locations in the garbage collection operation.

20. The data processing system of claim 19, wherein in executing the set of instructions to detect that the set of live objects in the set of first locations have been moved to the set of second locations in the garbage collection operation, the processing unit further executes the set of instructions to detect that a reference in the set of references refers to a first location in the set of first locations for a live object in the set of live objects.
